(19) United States
(12) Patent Application Publication
(10) Pub. No.: US 2009/0241634 A1
(43) Pub. Date: Oct. 1, 2009

(54) Micromachined accelerometer and method with continuous self-testing

(76) Inventor: Cenk Acar, Irvine, CA (US)

Correspondence Address: EDWARD S. WRIGHT, 1100 ALMA STREET, SUITE 207, MENLO PARK, CA, 94025, US

(21) Appl. No.: 12/058,024

(22) Filed: Mar. 28, 2008

(51) Int. Cl. G01P 21/00; G01P 15/125

(52) U.S. Cl. 73/1.79; 73/514.32

(57) ABSTRACT

Micromachined accelerometer and method in which a proof mass is suspended above a substrate for movement in response to acceleration, electrodes form capacitors which change in capacitance in response to movement of the proof mass, processing circuitry responsive to the changes in capacitance provides an output signal corresponding to movement of the proof mass, a test signal is applied to the electrodes during use of the accelerometer to produce additional movement of the proof mass and a corresponding test signal component in the output signal, and the output signal is monitored to determine whether the accelerometer is operating normally by the presence of the test signal component in the output signal.

### BACKGROUND OF THE INVENTION

1. Field of Invention

This invention pertains generally to micromachined accelerometers and, more particularly, to a micromachined accelerometer and method with continuous self-testing.

2. Related Art

In safety-critical applications of micromachined accelerometers such as electronic stability control (ESC) systems in the automotive industry, fault detection can be of vital importance. Most commercially available micro-machined accelerometers perform a start-up test to check for failures before operation. However, with only a start-up test, failures occurring during operation of the system are not detected.

### SUMMARY OF THE INVENTION

The micromachined accelerometer of the invention has a proof mass for movement in response to acceleration, electrodes forming a capacitor which changes in capacitance in response to movement of the proof mass, processing circuitry responsive to the changes in capacitance for providing an output signal corresponding to movement of the proof mass, means for applying a test signal to the electrodes during use of the accelerometer to produce additional movement of the proof mass and a corresponding test signal component in the output signal, and means active during use of the accelerometer for monitoring the output signal to determine whether the accelerometer is operating normally by the presence of the test signal component in the output signal.

### BRIEF DESCRIPTION OF THE DRAWINGS

FIG. 1 is a schematic diagram of a mechanical equivalent of the sensing element in a micromachined accelerometer incorporating the invention.

FIG. 2 is a simplified block diagram of one embodiment of a micromachined accelerometer incorporating the invention.

FIG. 3 is a waveform diagram illustrating the operation of the embodiment of FIG. 2.

FIGS. 4-6 are simplified block diagrams of additional embodiments of a micromachined accelerometer incorporating the invention.

### DETAILED DESCRIPTION

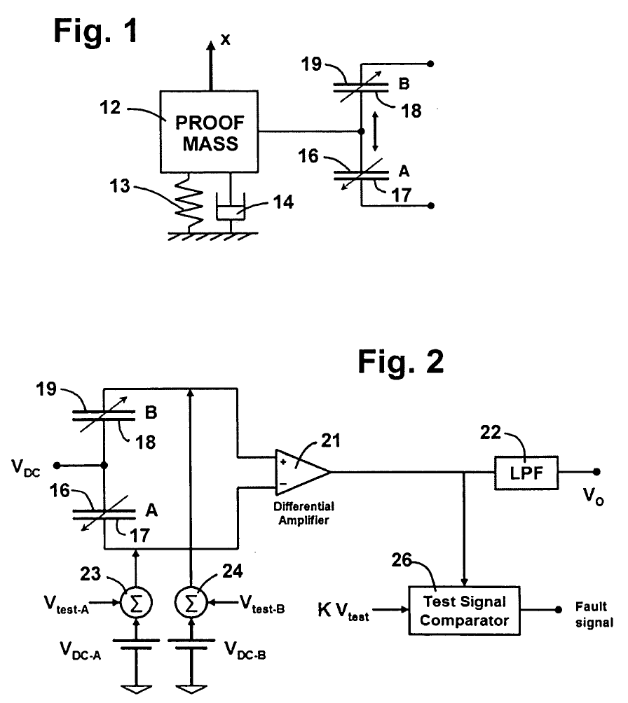

As illustrated in FIG. 1, the accelerometer includes a sensing element 11 having a proof mass 12 suspended above a substrate for movement in response to acceleration. In this figure, the sensing element is shown in an equivalent form comprising proof mass 12, a spring 13, and a damper 14.

The sensing element also includes electrodes 16-19 which form capacitors A, B with capacitances that change in response to displacement of the proof mass. In the embodiment illustrated, electrodes 16, 18 are carried by or connected to the proof mass and move with the proof mass relative to electrodes 17, 19 which are anchored to the substrate. The moving electrodes are positioned on opposite sides of the stationary electrodes, with electrode 16 above electrode 17, and electrode 18 below electrode 19, so that the capacitances of the two capacitors change in opposite directions. Thus, when proof mass 12 moves in a downward or −x direction in response to acceleration along the +x axis, electrode 16 moves closer to electrode 17, thereby increasing the capacitance of capacitor A. At the same time, electrode 18 moves away from electrode 19, decreasing the capacitance of capacitor B.

As illustrated in FIG. 2, electrodes 17, 19 are connected to the inputs of a differential amplifier 21, and a DC voltage V_{DC} is applied to electrodes 16, 18. Signals from the output of the differential amplifier are applied to a low pass filter 22 which delivers an output signal V_{O} corresponding to the movement of the proof mass. This differential processing of the signals from the sensing element is advantageous in linearizing the output of the accelerometer and minimizing bias.

Test signals V_{test-A} and V_{test-B} are combined with DC voltages V_{DC-A} and V_{DC-B} in summation circuits 23, 24 and applied to the stationary electrodes 17, 19 of the capacitors. Thus, the net voltages V_{A} and V_{B} applied to the capacitor are

V_{A}=V_{DC}−V_{DC-A}−V_{test-A}

V_{B}=V_{DC}−V_{DC-B}−V_{test-B}.

If V_{test-A}=−V_{test-B}=Vₜₑₛₜ and V_{DC-A}=V_{DC-B}, these expressions reduce to

V_{A}=V_{DC-net}−Vₜₑₛₜ

V_{B}=V_{DC-net}+Vₜₑₛₜ,

where V_{DC-net}=V_{DC}−V_{DC-A}=V_{DC}−V_{DC-B}.

The test signals generate an electrostatic force that deflects the proof mass. If the electrodes are symmetrical, then dC_{A}/dx=dC_{B}/dx=dC/dx, and the net electrostatic test force on the proof mass is

Fₜₑₛₜ=F_{A}−F_{B}=dC/dx(V_{A}²−V_{B}²)=4 dC/dx V_{DC-net} Vₜₑₛₜ.

The mechanical displacement of the proof mass in response to the test force is

xₜₑₛₜ=Fₜₑₛₜ/k,

where k is the mechanical spring constant. The resulting change in capacitance due to the test signal is

ΔCₜₑₛₜ=dC/dx xₜₑₛₜ=4/k(dC/dx)² V_{DC-net} Vₜₑₛₜ.

The component of the output signal due to the test signal is

V_{O}^{test}=4 K_{cap}/k(dC/dx)²V_{DC-net} Vₜₑₛₜ, or

V_{O}^{test}=K Vₜₑₛₜ,

where K_{cap} is the capacitance to voltage conversion gain of the amplifiers in the processing circuitry, and K is the overall scale factor from Vₜₑₛₜ to V_{O}^{test}.

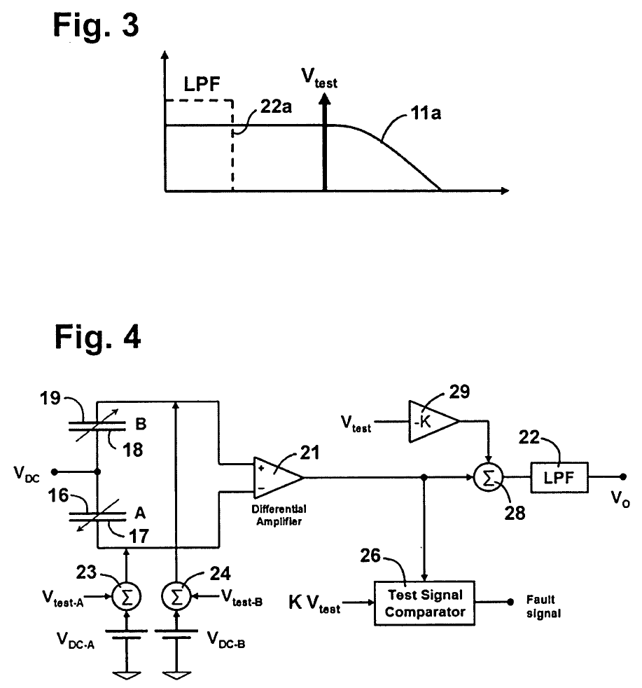

The test signal can, for example, be a sinusoidal voltage at a frequency higher than the bandwidth of the system, but lower than the roll-off frequency of the sensing element. Thus, as illustrated in FIG. 3, the frequency of the test signal Vₜₑₛₜ is within the operating range 23 of sensing element 11 but outside the passband 24 of low pass filter 22. This allows the component of the output signal due to the test signal to be readily separated from the component due to acceleration, while preventing the test signal response from being suppressed by the dynamics of the sensing element at high frequencies.

Means is provided for monitoring the output signal to detect the presence of the test signal component as an indication that the system is operating properly. This means includes a test signal comparator circuit 26, with the output of differential amplifier 21 being applied to one input of the comparator and a signal corresponding to test signal Vₜₑₛₜ being applied to another.

During calibration of the accelerometer, the response of the system to the test signal is measured, and the scale factor K is calculated for Vₜₑₛₜ to V_{O}^{test}. During operation, the component of the output signal due to the test signal is continuously monitored and compared with the initially calculated value. If there is a failure either in the sensing element and/or in the processing circuitry, the actual response will not match the calculated value, and the comparator will deliver a fault signal.

Low pass filter 22 sets the bandwidth of the accelerometer and also removes the test signal component V_{O}^{test} from the output signal.

In order to improve the efficiency of the removal of the test signal component, a signal equal and opposite to that component can be injected into the output signal prior to the low-pass filter. One way of doing so is illustrated in FIG. 4 where a summing circuit 28 is connected between differential amplifier 21 and low pass filter 22, and an amplifier 29 having a gain equal to −K is connected to another input of the summing circuit. Test signal Vₜₑₛₜ is applied to the input of amplifier 29 to provide a signal equal to −V_{O}^{test} which is combined with the signal from the differential amplifier in the summing circuit to cancel the test signal component from the output signal before it gets to the low pass filter.

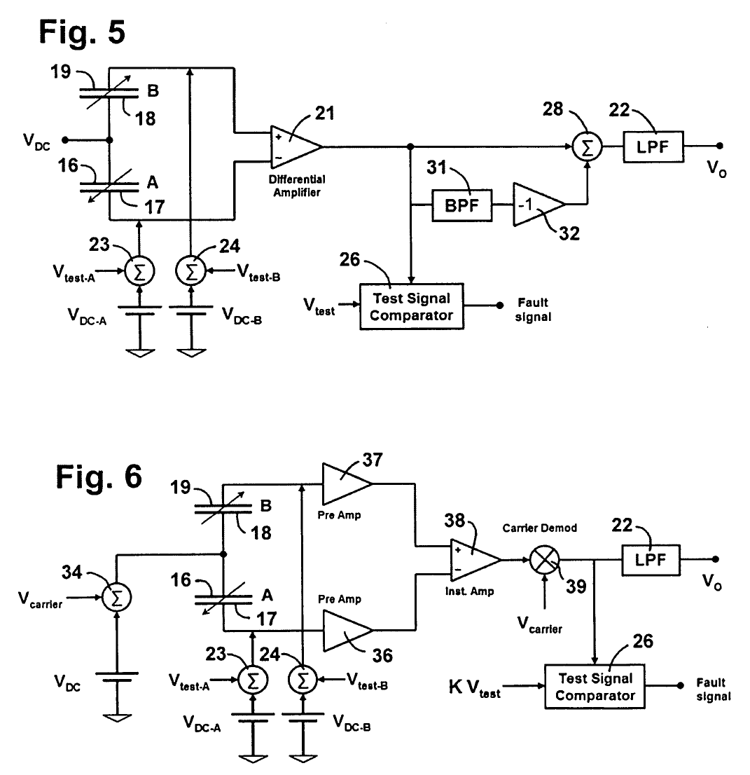

FIG. 5 illustrates another embodiment which includes means for eliminating the test signal component prior to the low pass filter. In this embodiment, a band pass filter 31 centered at the frequency of the test signal is connected to the output of differential amplifier 21, and a summing circuit 28 is once again connected between the differential amplifier and the low pass filter. The output of the band pass filter is applied to a second input of the summing circuit through a unity gain inverting amplifier 32. The band pass filter extracts the test signal component of the output signal, and the negative of that signal is fed forward into the output signal. Thus, the test signal component is subtracted from the output signal before the output signal passes through the low pass filter.

The disclosed continuous self-testing of the invention can be implemented in any micromachined capacitive accelerometer that allows injection of an AC signal into the detection capacitors, regardless of the type of detection employed in the accelerometer.

FIG. 6 illustrates an embodiment in which continuous self-testing is provided in an accelerometer with synchronous demodulation. In this embodiment, a very high frequency carrier signal is imposed on the detection capacitors, and the output signal is demodulated at the carrier frequency. The carrier signal V_{carrier} is imposed on the capacitors by combining it with the DC voltage VDC in a summing circuit 34 and applying the output of the summing circuit to electrodes 16, 18.

Electrodes 17, 19 are connected to the inputs of preamplifiers 36, 37, and the outputs of the preamplifiers are connected to the inputs of an instrumentation amplifier 38. The output of the instrumentation amplifier is connected to the input of a synchronous demodulator 39, and the carrier signal V_{carrier} is applied to the carrier input of the demodulator. The output of the demodulator is connected to the inputs of low pass filter 22 and test signal comparator 26. As in the previous embodiments, the low pass filter removes the test signal component from the output signal, and the comparator compares the test signal component with the expected response to the test signal.

The test signal is at a known frequency and phase, and the frequency and phase of the test signal component of the output signal are also well known. This allows very efficient identification and distinction of the test signal response.

There is, however, a possibility that the accelerometer might experience external vibrations at same frequency and phase as the test signal. To avoid such vibrations from giving rise to a false indication of a fault in the accelerometer, a second check is performed in the test signal comparator block before delivering a fault signal.

In one embodiment, when the test response is not equal to the expected value, the injection of the test signal injection is interrupted, and the test signal components of the output signal immediately before and after the interruption are compared. If the difference between the two components is equal to the expected test response, no fault signal is delivered. Alternatively, instead of interruption, the test signal can be altered in another way such as increasing or decreasing its magnitude or changing its frequency or phase, and then comparing the test signal components in the output signal before and after the change is made.

Another alternative is to use a composite test signal having more than one frequency component. With non-linear mixing of the frequency components, difference frequencies can be monitored, and a composite test signal is less likely to be disturbed by external vibration than a single frequency test signal.

The invention has a number of important features and advantages. Continuous self-testing during operation makes it possible to detect failures as they occur in the accelerometer, and this capability is vitally important in safety-critical applications such as electronic stability control systems in automobiles.

It is apparent from the foregoing that a new and improved micromachined accelerometer and method with continuous self-testing have been provided. While only certain presently preferred embodiments have been described in detail, as will be apparent to those familiar with the art, certain changes and modifications can be made without departing from the scope of the invention as defined by the following claims.

1. A micromachined accelerometer having a proof mass for movement in response to acceleration, electrodes forming a capacitor which changes in capacitance in response to movement of the proof mass, processing circuitry responsive to the changes in capacitance for providing an output signal corresponding to movement of the proof mass, means for applying a test signal to the electrodes during use of the accelerometer to produce additional movement of the proof mass and a corresponding test signal component in the output signal, and means active during use of the accelerometer for monitoring the output signal to determine whether the accelerometer is operating normally by the presence of the test signal component in the output signal.

2. The accelerometer of claim 1 including means for eliminating the test signal component from the output signal.

3. The accelerometer of claim 2 wherein the means for eliminating the test signal component includes means for filtering the output signal to remove the test signal component.

4. The accelerometer of claim 2 wherein the means for eliminating the test signal component includes means for subtracting a signal corresponding to the test signal component from the output signal.

5. The accelerometer of claim 1 including means for imposing a high frequency carrier signal on the electrodes and means for demodulating the output signal at the carrier signal frequency.

6. The accelerometer of claim 1 including a second set of electrodes which form a second capacitor that changes in capacitance in response to movement of the proof mass, with the test signal also being applied to the second set of electrodes and the processing circuitry also responding to the changes in capacitance of the second capacitor.

7. A method of monitoring acceleration with a micromachined accelerometer having a proof mass that moves in response to acceleration, electrodes forming a capacitor which changes in capacitance in response to movement of the proof mass, and processing circuitry responsive to the changes in capacitance for providing an output signal corresponding to movement of the proof mass, comprising the steps of: continuously applying a test signal to the electrodes during use of the accelerometer to produce additional movement of the proof mass and a corresponding test signal component in the output signal, and monitoring the output signal during use of the accelerometer to determine whether the accelerometer is operating normally by the presence of the test signal component in the output signal.

8. The method of claim 7 including the step of filtering the output signal to remove the test signal component.

9. The method of claim 7 including the step of subtracting a signal corresponding to the test signal component from the output signal.

10. The method of claim 7 including the steps of imposing a high frequency carrier signal on the electrodes and demodulating the output signal at the carrier signal frequency.

11. The method of claim 7 including the steps of monitoring a component of the output signal at a frequency corresponding to the test signal, altering the test signal applied to the electrodes in the event of a change in the test frequency component of the output signal, and comparing the test frequency components before and after the change occurs to determine whether the change was due to a fault in the accelerometer.

12. The method of claim 11 wherein the test signal is altered by interrupting the application of the test signal to the electrodes.

13. The method of claim 11 wherein the test signal is altered by changing the frequency of the test signal.

14. The method of claim 11 wherein the test signal is altered by changing the phase of the test signal.

15. The method of claim 7 wherein the test signal is a composite test signal having more than one frequency component.

16. The method of claim 7 wherein the accelerometer has a second set of electrodes which form a second capacitor that changes in capacitance in response to movement of the proof mass, and the test signal is also applied to the second set of electrodes.

17. The method of claim 16 wherein the capacitances of the two capacitors change in opposite directions, and signals from the two capacitors are combined differentially in the processing circuitry.

18. A micromachined accelerometer having a proof mass for movement in response to acceleration, first and second sets of electrodes forming capacitors which change in capacitance in response to movement of the proof mass, processing circuitry responsive to the changes in capacitance for providing an output signal corresponding to movement of the proof mass, means for applying a test signal to the electrodes during use of the accelerometer to produce additional movement of the proof mass and a corresponding test signal component in the output signal, and means active during use of the accelerometer for monitoring the output signal to determine whether the accelerometer is operating normally by the presence of the test signal component in the output signal.

19. The accelerometer of claim 18 wherein the capacitors change capacitance in opposite directions, and the processing circuitry includes means for differentially combining signals from the capacitors.

20. The accelerometer of claim 18 including means for filtering the output signal to remove the test signal component.

21. The accelerometer of claim 18 including means for subtracting a signal corresponding to the test signal component from the output signal.

22. The accelerometer of claim 18 including means for imposing a high frequency carrier signal on the electrodes and means for demodulating the output signal at the carrier signal frequency.
